(19) United States
(12) Patent Application Publication
(10) Pub. No.: US 2013/0136557 A1
(43) Pub. Date: May 30, 2013

(54) Bolt assembly

(71) Applicant: Yuan yu Wang, Taichung (TW)

(72) Inventor: Yuan yu Wang, Taichung (TW)

(21) Appl. No.: 13/306,991

(22) Filed: Nov. 30, 2011

(51) Int. Cl. F16B 31/00

(52) U.S. Cl. 411/1

(57) ABSTRACT

A bolt assembly is provided with a bearing seat, a screw, a pull member and a cover. The bearing seat has a through hole, a concave portion and an accommodation room. The screw is coupled to the bearing seat. The screw includes a threaded portion, a head portion and a pull groove. The threaded portion extends out of the through hole. The head portion is positioned in the concave portion. The pull groove is located corresponding to the accommodation room. The pull member is located on top of the bearing seat. The pull member has at least one pull point at a lower end thereof. The pull point extends in the accommodation room and is located corresponding to the pull groove of the screw. The cover is adapted to cover the bearing seat and confines the pull member in the cover.

### BACKGROUND OF THE INVENTION

1. Field of the Invention

The present invention relates to a bolt assembly, and more particularly to a bolt assembly which is used to lock different articles and prevents the articles from being disassembled and is cost-effective.

2. Description of Related Art

A screw is widely used to lock an article. In general, the article is locked to an object through the screw. The screw can be unscrewed to release connection of the article and the object. Some articles need the demand of anti-disassembly after being locked, such as a license plate fixed to a vehicle through screws and nuts. License plates are easy to be stolen with a wrench. A conventional anti-disassembly device is commercially available and the conventional anti-disassembly device comprises a screw and a nut. The screw comprises at least one rib plate which is formed between a connection portion and an edge portion. The central hole of the nut has an engaging recess which is located corresponding to the rib plate and against the rib plate. A wrench is used to turn the nut which links the screw to be a fastened state. By applying more force with the wrench, the rib plat is cut off by the shear force generated from the cross-section of each engaging recess, so that the screw and the nut will be idle to provide an anti-disassembly effect. This kind of screw with at least one rib plate is not normal. It is more difficult to manufacture this specific screw, and the cost is high. It is not easy to change the strength of the rib plate as desired, including heat treatment of the screw. If the rib plate is too hard, it will be difficult to cut off the rib plate. This may influence the strength of the screw when locked. In addition, the central hole of the nut has at least one engaging recess. The nut cannot be manufactured by a normal lathe or CNC lathe. The cost of this anti-disassembly device is high. It is difficult to set and change the lock force of the screw, which is not beneficial to be used. Accordingly, a novel anti-disassembly device which can be manufactured with ease and is cost-effective is provided below.

### SUMMARY OF THE INVENTION

It is therefore one object of the invention to provide a bolt assembly which comprises a bearing seat, a screw, a pull member and a cover. The bearing seat has a hexagon shape. The bearing seat has a central stepped hole which is composed of a through hole, a concave portion and an accommodation room. The screw is coupled to the bearing seat. The screw comprises a threaded portion, a head portion and a pull groove. The threaded portion extends out of the through hole. The head portion is positioned in the concave portion. The pull groove is located corresponding to the accommodation room. The pull member is a hexagon plate corresponding in shape to the bearing seat. The pull member is located on top of the bearing seat. The pull member has at least one pull point at a lower end thereof. The pull point extends in the accommodation room and is located corresponding to the pull groove of the screw.

The cover is a hexagon sleeve corresponding in shape to the bearing seat. The cover is adapted to cover the bearing seat and confines the pull member in the cover. The cover has an angled surface for operation of a wrench. The threaded portion of the screw extends out of the bearing seat and is screwed in a threaded hole of an object. Through the wrench to operate the angled surface of the cover, the pull member is turned along with turning of the cover and the pull point located in the pull groove of the screw brings the screw to lock an article. When the article is tightly fastened, the wrench continues applying a force on the angled surface of the cover to turn the pull member. When tightened, the pull groove of the screw generates a certain stop force to the pull point such that the pull point is squeezed and deformed to disengage from the pull groove. After the article is locked, the pull point of the pull member is deformed to release the interlocking relationship between the pull member, so that the screw will be turned no more when applying a force on the angled surface of the cover, providing an anti-disassembly effect to the article. Through the applied force setting and variation of the pull point of the pull member, the article can be locked tightly as desired. The production cost of each part is low, so the present invention is cost-effective.

Preferably, the pull point of the pull member is formed by cutting a portion of the pull member and then the cut portion is pressed downward to form the pull point. The pull pint has a strength which is changeable by changing the material or the thickness or the shape of the pull member. The bolt assembly is able to be manufactured in different standards according to the strength of the pull point for locking different articles.

Preferably, the cover has a plurality of clamping portions which are able to be bent. When the cover is fitted on the bearing seat, the clamping portions are bent at a bottom end of the bearing seat to provide a clamping effect, so that the cover covers the bearing seat tightly and the pull member is secured in the cover to be driven.

The above and other objects, features and advantages of the invention will become apparent from the following detailed description taken with the accompanying drawings.

### BRIEF DESCRIPTION OF THE DRAWINGS

FIG. 1 is an exploded view according to a preferred embodiment of the present invention;

FIG. 2 is an assembled and perspective view according to the preferred embodiment of the present invention;

FIG. 3 is a sectional view according to the preferred embodiment of the present invention;

FIG. 4 is a sectional view showing the pull member according to the preferred embodiment of the present invention;

FIG. 5 is a schematic view showing the pull point of the pull member according to the preferred embodiment of the present invention;

FIG. 6 is a schematic view showing the position of the pull member when the article is in a locking state according to the preferred embodiment of the present invention;

FIG. 7 is a sectional view of preferred embodiment of the present invention when the article is in a locking state;

FIG. 8 is a schematic view showing the position of the pull member after the article is locked according to the preferred embodiment of the present invention;

FIG. 9 is a sectional view of preferred embodiment of the present invention after the article is locked; and

FIG. 10 is a schematic view showing deformation of the pull point after the article is locked according to the preferred embodiment of the present invention;

### DETAILED DESCRIPTION OF THE INVENTION

Embodiments of the present invention will now be described, by way of example only, with reference to the accompanying drawings.

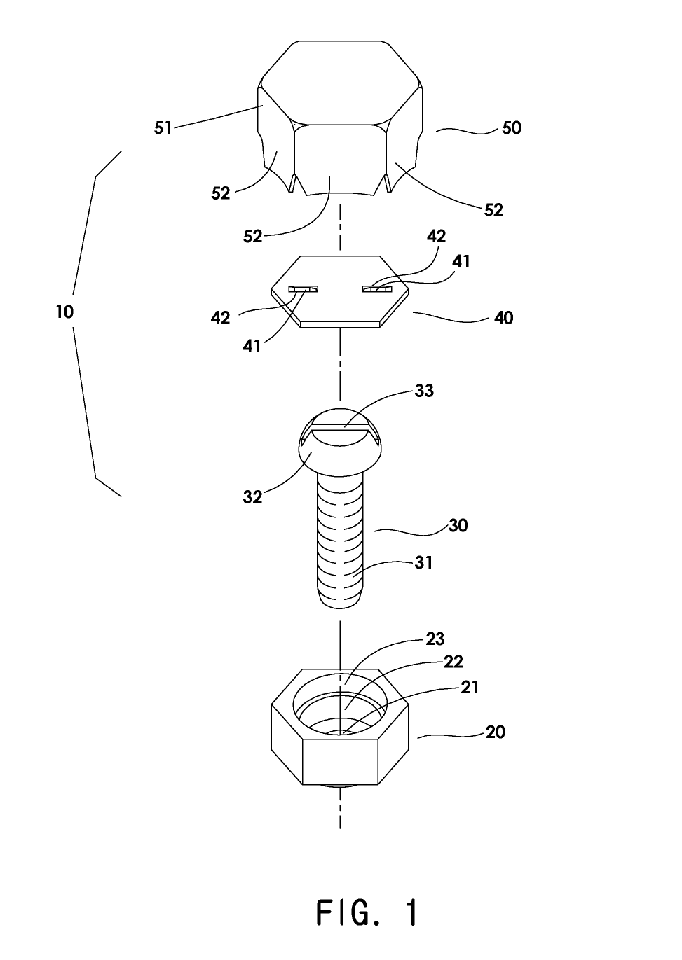

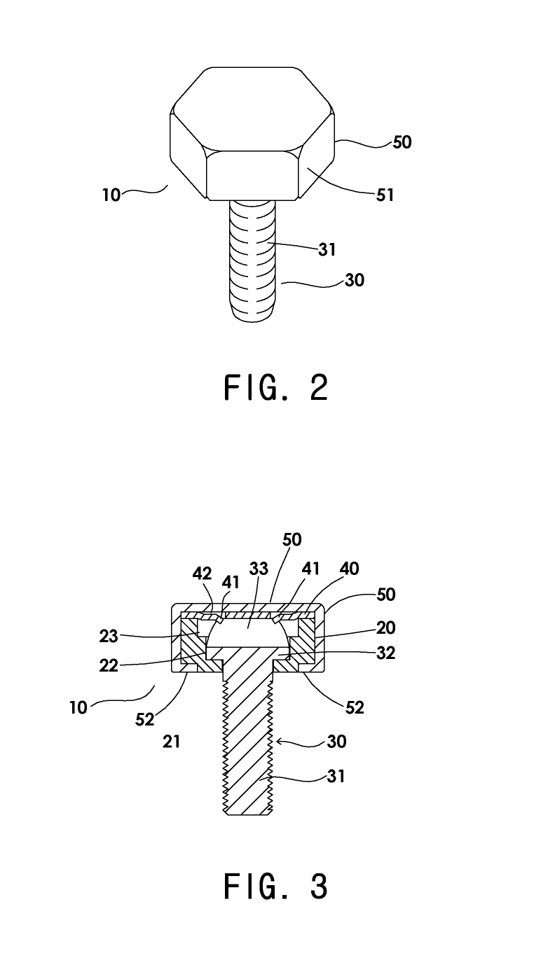

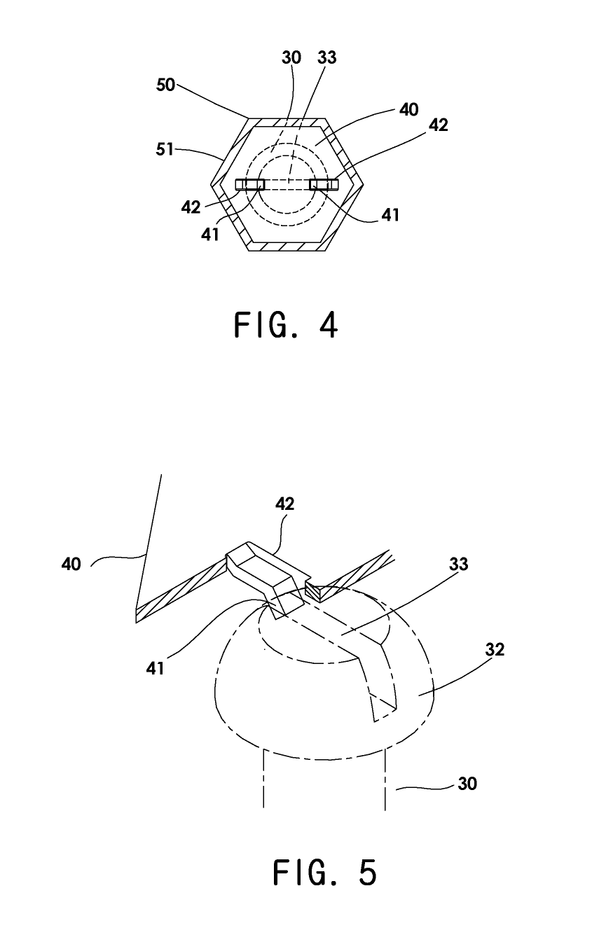

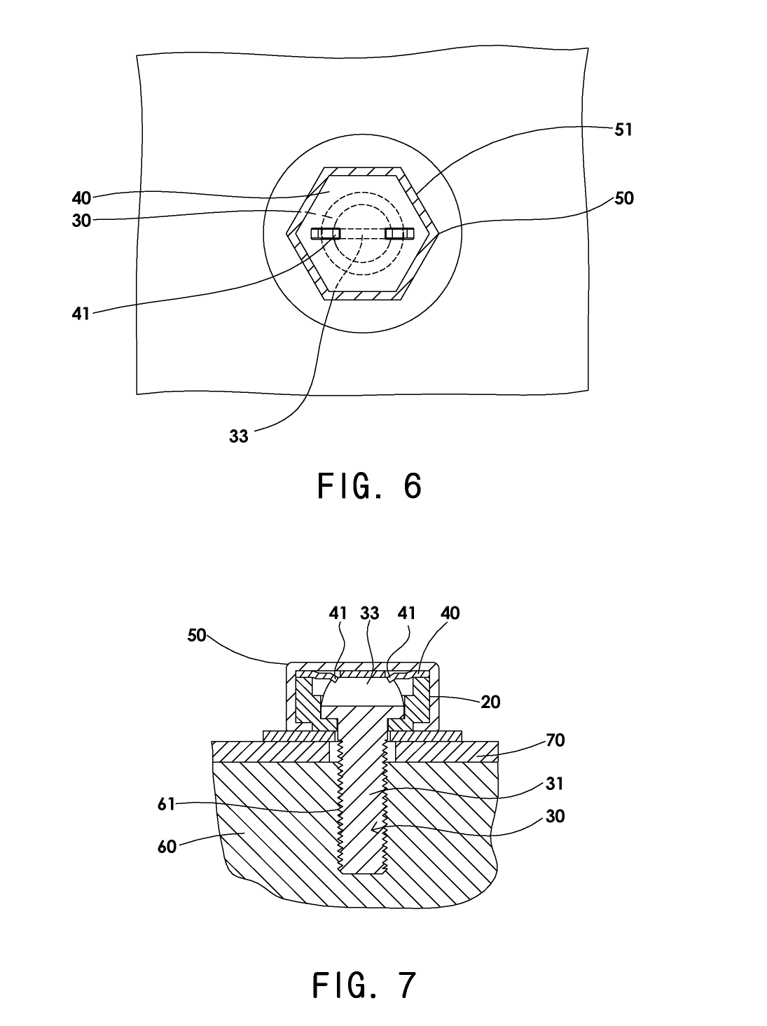

Referring to FIG. 1 through FIG. 10, the bolt assembly of the present invention comprises a bearing seat 20, a screw 30, a pull member 40 and a cover 50. The bearing seat 20 has a hexagon shape. The bearing seat 20 has a central stepped hole which is composed of a through hole 21, a concave portion 22 and an accommodation room 23. The screw 30 is coupled to the bearing seat 20. The screw 30 comprises a threaded portion 31, a head portion 32 and a pull groove 33. The threaded portion 31 extends out of the through hole 21, the head portion 32 is positioned in the concave portion 22, and the pull groove 33 is located corresponding to the accommodation room 23. The pull member 40 is a hexagon plate corresponding in shape to the bearing seat 20. The pull member 40 is located on top of the bearing seat 20. The pull member 40 has at least one pull point 41 at a lower end thereof. The pull point 41 extends in the accommodation room 23 and is located corresponding to the pull groove 33 of the screw 30. The cover 50 is a hexagon sleeve corresponding in shape to the bearing seat 20. The cover 50 is used to cover the bearing seat 20 and confine the pull member 40 in the sleeve. The cover 50 has an angled surface 51 for operation of a wrench. As shown in FIG. 6 and FIG. 7, the threaded portion 31 of the screw 30 extends out of the bearing seat 20 and is screwed in a threaded hole 61 of an object 60.

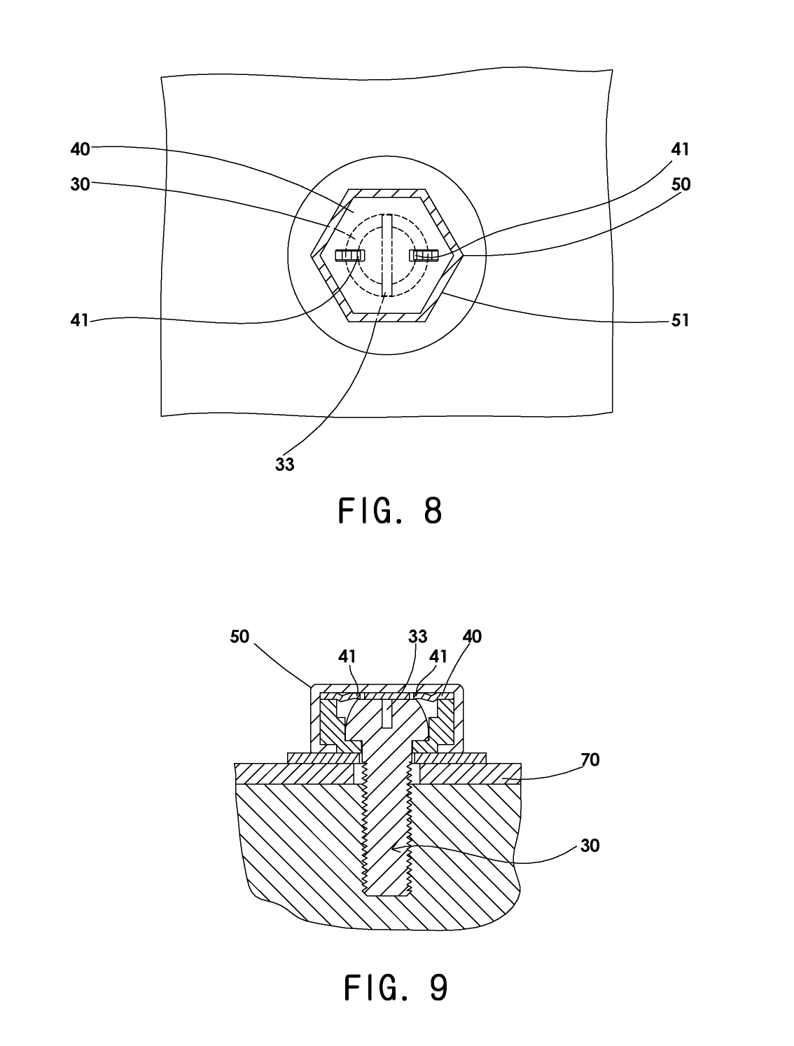

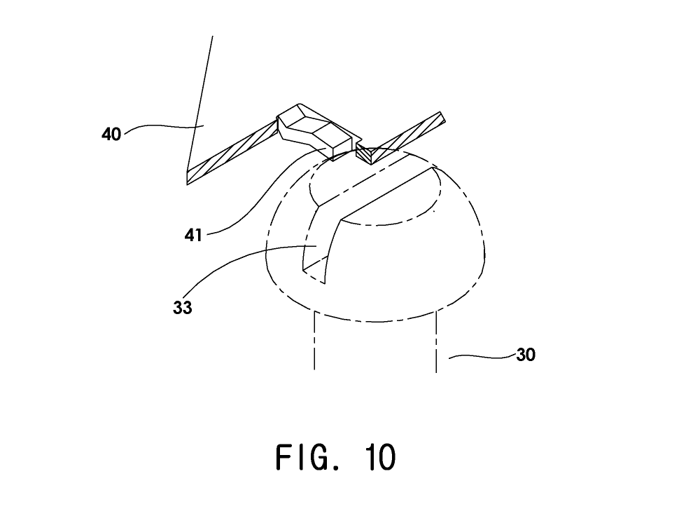

Through the wrench to operate the angled surface 51 of the cover 50, the pull member 40 is turned along with turning of the cover 50 and the pull point 41 located in the pull groove 33 of the screw 30 brings the screw 30 to lock an article 70. When the article 70 is tightly fastened, the wrench continues applying a force on the angled surface 51 of the cover 50 to turn the pull member 40, as shown in FIG. 8, FIG. 9 and FIG. 10. When tightened, the pull groove 33 of the screw 30 generates a certain stop force to the pull point 41, such that the pull point 41 is squeezed and deformed to disengage from the pull groove 33. After the article 70 is locked, the pull point 41 of the pull member 40 is deformed to release the interlocking relationship between the pull member 40, so that the screw 30 will be turned no more when applying a force on the angled surface 51 of the cover 50, providing an anti-disassembly effect to the article 70. As shown in FIG. 1 through FIG. 4, through the applied force setting and variation of the pull point 41 of the pull member 40, the article can be locked tightly as desired. The production cost of each part is low, so the present invention is cost-effective.

According to the aforesaid embodiment, the bearing seat 20 as shown in FIG. 1 can be manufactured with a hexagon metal bar to be processed by a CNC lathe. The screw 30 is a conventional screw. The pull member 40 is formed with a metal plate to be lathed by a lathe. The cover 50 is formed with a metal cover to be extruded by a lathe. Each part can be manufactured by a common tool machine, so the production and use of the bolt assembly 10 has economic benefits.

According to the aforesaid embodiment as shown in FIG. 1 through FIG. 5, the pull point 41 of the pull member 40 is formed by cutting a portion 42 of the pull member 40 and then the cut portion 42 is pressed downward to form the pull point 41. The pull pint 41 can have a different strength by means of changing the material or the thickness or the shape of the pull member 40. The bolt assembly 10 can be manufactured in different standards according to the strength of the pull point 41 for locking different articles.

According to the aforesaid embodiment as shown in FIG. 1 and FIG. 3, the cover 50 which is a hexagon sleeve has a plurality of clamping portions 52. The clamping portions 52 are able to be bent. When the cover 50 is fitted on the bearing seat 20, the clamping portions 52 are bent at a bottom end of the bearing seat 20 to provide a clamping effect, so that the cover 50 covers the bearing seat 20 tightly and the pull member 40 is secured in the cover 50 to be driven.

While the invention has been described in terms of preferred embodiments, those skilled in the art will recognize that the invention can be practiced with modifications within the spirit and scope of the appended claims.

What is claimed is:

1. A bolt assembly, comprising:
a bearing seat, a screw, a pull member, and a cover;
the bearing seat having a hexagon shape, the bearing seat having a central stepped hole which is composed of a through hole, a concave portion and an accommodation room;
the screw being coupled to the bearing seat, the screw comprising a threaded portion, a head portion and a pull groove, the threaded portion extending out of the through hole, the head portion being positioned in the concave portion, the pull groove being located corresponding to the accommodation room;
the pull member being a hexagon plate corresponding in shape to the bearing seat, the pull member being located on top of the bearing seat, the pull member having at least one pull point at a lower end thereof, the pull point extending in the accommodation room and being located corresponding to the pull groove of the screw;
the cover being a hexagon sleeve corresponding in shape to the bearing seat, the cover being adapted to cover the bearing seat and confining the pull member in the cover, the cover having an angled surface for operation of a wrench;
the threaded portion of the screw extending out of the bearing seat and being screwed in a threaded hole of an object, through the wrench to operate the angled surface of the cover, the pull member being turned along with turning of the cover and the pull point located in the pull groove of the screw bringing the screw to lock an article; and
when the article is tightly fastened, the wrench continuing applying a force on the angled surface of the cover to turn the pull member, when tightened, the pull groove of the screw generating a certain stop force to the pull point such that the pull point is squeezed and deformed to disengage from the pull groove.

2. The bolt assembly as claimed in claim 1, wherein the pull point of the pull member is formed by cutting a portion of the pull member and then the cut portion is pressed downward to form the pull point; the pull pint has a strength which is changeable by changing the material or the thickness or the shape of the pull member, and the bolt assembly is able to be manufactured in different standards according to the strength of the pull point for locking different articles.

3. The bolt assembly as claimed in claim 1, wherein the cover has a plurality of clamping portions which are able to be bent; when the cover is fitted on the bearing seat, the clamping portions are bent at a bottom end of the bearing seat to provide a clamping effect, so that the cover covers the bearing seat tightly and the pull member is secured in the cover to be driven.
